(19) United States
(12) Patent Application Publication
(10) Pub. No.: US 2024/0037298 A1
(43) Pub. Date: Feb. 1, 2024

(54) PARAMETER DERIVING DEVICE, PARAMETER DERIVING METHOD, AND PARAMETER DERIVING PROGRAM

(71) Applicant: Tokyo Electron Limited, Tokyo (JP)

(72) Inventors: Takahiko KATO, Miyagi (JP); Hironori MOKI, Miyagi (JP)

(21) Appl. No.: 18/258,471

(22) PCT Filed: Dec. 15, 2021
(86) PCT No.: PCT/JP2021/046220

§ 371 Date: Jun. 20, 2023

(30) Foreign Application Priority Data
Dec. 28, 2020 (JP) 2020-218976

(51) Int. Cl. G06F 30/27; G06F 30/10

(52) U.S. Cl. CPC G06F 30/27; G06F 30/10

(57) ABSTRACT

A global optimum solution of a simulation parameter is derived using a shape simulator. A parameter deriving device includes a generating unit configured to generate a plurality of combinations of data indicating pre-processing shapes and data indicating post-processing shapes of substrates processed under a same processing condition, data indicating a pre-processing shape or a post-processing shape being different from data indicating a pre-processing shape or a post-processing shape included in another combination in the plurality of combinations, and a deriving unit configured to derive a value of a simulation parameter of a shape simulator that minimizes a sum of respective differences between data indicating predicted post-processing shapes and data indicating corresponding post-processing shapes, the predicted post-processing shapes being predicted by inputting the data indicating the pre-processing shapes included in the plurality of combinations into the shape simulator.

### TECHNICAL FIELD

The present disclosure relates to a parameter deriving device, a parameter deriving method, and a parameter deriving program.

### BACKGROUND ART

In the field of substrate processing apparatuses, a shape simulator is conventionally used to predict a substrate shape. The shape simulator is an apparatus that predicts a substrate shape after processing in a case where a substrate is processed under a predetermined processing condition.

According to the shape simulator, a predicted post-processing cross-sectional image indicating a cross-sectional shape of a substrate after processing can be predicted by inputting a pre-processing cross-sectional image indicating a cross-sectional shape of a substrate before processing and information on a predetermined processing condition (referred to as a “simulation parameter”).

In addition, by using the shape simulator, for example, an optimum simulation parameter for obtaining a desired post-processing cross-sectional image can be derived from the pre-processing cross-sectional image.

### RELATED-ART DOCUMENT

### Patent Document

[Patent Document 1] Japanese Laid-Open Patent Application Publication No. 2017-135365

### SUMMARY OF THE INVENTION

### Problem to be Solved by the Invention

However, in the shape simulator as described above, when pre-processing cross-sectional images having different cross-sectional shapes are input, even if the cross-sectional shapes change similarly between before and after the processing, respective different simulation parameters are derived. That is, the optimum simulation parameter derived for each of the post-processing cross-sectional images in the shape simulator can be regarded as a local optimum solution.

With respect to the above, when the changes in the cross-sectional shapes between before and after the processing are identical, it is desirable that the derived optimum simulation parameters are also identical (that is, a global optimum solution is derived) regardless of the differences in the cross-sectional shapes before processing.

The present disclosure provides a parameter deriving device, a parameter deriving method, and a parameter deriving program that derive a global optimum solution of a simulation parameter by using a shape simulator.

### Means for Solving Problem

A parameter deriving device according to an aspect of the present disclosure includes, for example, the following configuration:
a generating unit configured to generate a plurality of combinations of data indicating pre-processing shapes and data indicating post-processing shapes of substrates processed under a same processing condition, data indicating a pre-processing shape or a post-processing shape being different from data indicating a pre-processing shape or a post-processing shape included in another combination in the plurality of combinations; and
a deriving unit configured to derive a value of a simulation parameter of a shape simulator that minimizes a sum of respective differences between data indicating predicted post-processing shapes and data indicating corresponding post-processing shapes, the predicted post-processing shapes being predicted by inputting the data indicating the pre-processing shapes included in the plurality of combinations into the shape simulator.

### Effect of Invention

A parameter deriving device, a parameter deriving method, and a parameter deriving program that derive a global optimum solution of a simulation parameter using a shape simulator can be provided.

### BRIEF DESCRIPTION OF THE DRAWINGS

FIG. 1 is a diagram illustrating an example of a system configuration of a shape simulation system.

FIG. 2 is a diagram illustrating an example of a hardware configuration of a parameter deriving device.

FIG. 3 is a diagram illustrating an example of collection data stored in a collection data storage unit.

FIG. 4 is a first diagram illustrating an example of a functional configuration of the parameter deriving device.

FIG. 5 is a diagram illustrating a specific example of processing of a simulation data generating unit.

FIG. 6 is a diagram illustrating a specific example of simulation data stored in a simulation data storage unit.

FIG. 7 is a diagram illustrating a specific example of processing of an aggregating unit.

FIG. 8 is a first diagram illustrating a specific example of processing of a simulation parameter calculating unit.

FIG. 9 is a diagram illustrating a specific example of processing of a difference calculating unit.

FIG. 10 is a first flowchart illustrating a flow of a simulation parameter deriving process.

FIG. 11 is a second diagram illustrating an example of the functional configuration of the parameter deriving device.

FIG. 12 is a diagram illustrating a specific example of processing of a constraint condition determining unit.

FIG. 13 is a diagram illustrating a specific example of constraint conditions.

FIG. 14 is a second diagram illustrating a specific example of the processing of the simulation parameter calculating unit.

FIG. 15 is a second flowchart illustrating the flow of the simulation parameter deriving process.

FIG. 16 is a third diagram illustrating a specific example of the processing of the simulation parameter calculating unit.

FIG. 17 is a diagram for explaining an outline of the design of experiments.

FIG. 18 is a third flowchart illustrating the flow of the simulation parameter deriving process.

### DESCRIPTION OF EMBODIMENTS

In the following, embodiments will be described with reference to the accompanying drawings. Here, in the present specification and the drawings, components having substantially the same functional configuration are denoted by the same reference numerals, and duplicated description is omitted.

### First Embodiment

<System Configuration of a Shape Simulation System>

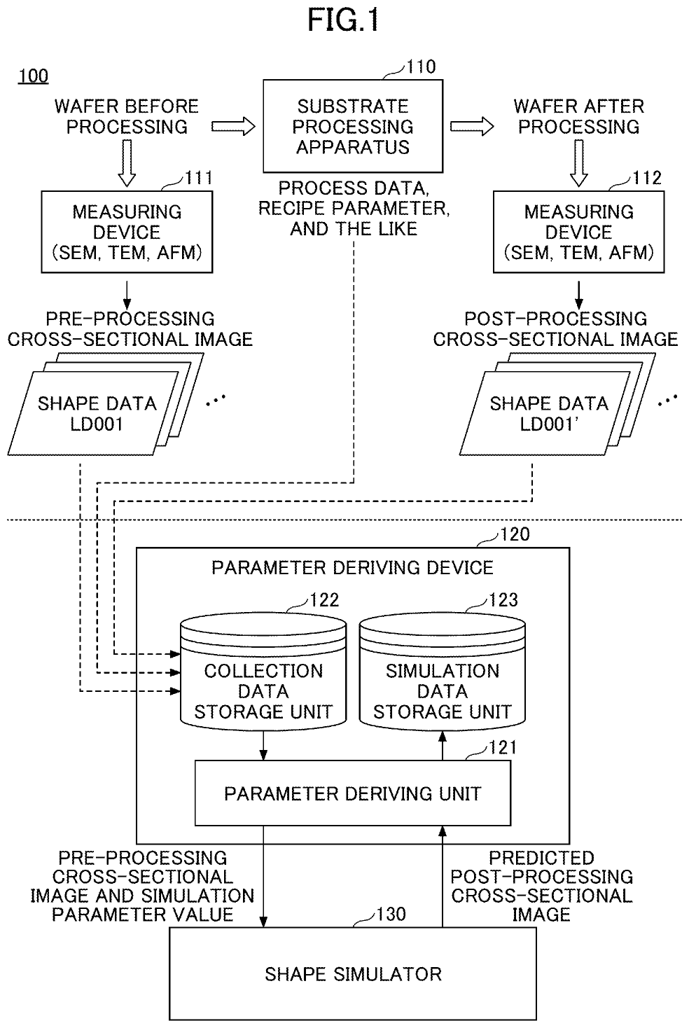

First, a system configuration of an entirety of a shape simulation system including a parameter deriving device according to a first embodiment will be described. FIG. 1 is a diagram illustrating an example of the system configuration of the shape simulation system.

As illustrated in FIG. 1, a shape simulation system 100 includes a substrate processing apparatus 110, measuring devices 111 and 112, a parameter deriving device 120, and a shape simulator 130.

In FIG. 1, the substrate processing apparatus 110 performs various substrate manufacturing processes (for example, dry etching and deposition) when multiple wafers before processing (target objects) are transferred.

Here, some wafers before processing among the multiple wafers before processing are transferred to the measuring device 111, are cut in the cross-sectional direction at various positions, and then cross-sectional shapes are measured by the measuring device 111. This allows the measuring device 111 to generate a pre-processing cross-sectional image indicating the cross-sectional shape of the wafer before processing. Here, the measuring device 111 includes a scanning electron microscope (SEM), a transmission electron microscope (TEM), an atomic force microscope (AFM), or the like.

The example of FIG. 1 illustrates a state in which the measuring device 111 generates pre-processing cross-sectional images having file names=“shape data LD001”, “shape data LD002”, “shape data LD003”, and the like.

With respect to the above, when various substrate manufacturing processes are performed, a wafer after processing is transferred from the substrate processing apparatus 110. At this time, in the substrate processing apparatus 110, a processing condition (process data acquired during the performance of various substrate manufacturing processes, recipe parameters used when various substrate manufacturing processes are performed, and the like) is held.

Some wafers after processing among multiple wafers after processing that are transferred from the substrate processing apparatus 110 as the wafers after processing are transferred to the measuring device 112, are cut in the cross-sectional direction at various positions, and then cross-sectional shapes are measured by the measuring device 112. This allows the measuring device 112 to generate a post-processing cross-sectional image indicating the cross-sectional shape of the wafer after processing. Here, similarly with the measuring device 111, the measuring device 112 includes a scanning electron microscope (SEM), a transmission electron microscope (TEM), an atomic force microscope (AFM), or the like.

The example of FIG. 1 illustrates a state in which the measuring device 112 generates post-processing cross-sectional images having file names=“shape data LD001′”, “shape data LD002′”, “shape-data LD003′”, and the like.

The pre-processing cross-sectional image generated by the measuring device 111, the process data, the recipe parameters, and the like held by the substrate processing apparatus 110, and the post-processing cross-sectional image generated by the measuring device 112 are transmitted to the parameter deriving device 120 as collection data. This allows the collection data to be stored in a collection data storage unit 122 of the parameter deriving device 120.

A parameter deriving program is installed in the parameter deriving device 120, and the parameter deriving device 120 functions as a parameter deriving unit 121 by executing the program.

The parameter deriving unit 121 reads the collection data stored in the collection data storage unit 122, generates simulation data to be input to the shape simulator 130, and then stores the generated simulation data in a simulation data storage unit 123.

The simulation data includes multiple combinations of the pre-processing cross-sectional images and the post-processing cross-sectional images included in the collection data as an example of combinations of data indicating the shapes of the substrates before processing and data indicating the shapes of the substrates after processing. The simulation data is classified and managed for each group of the processing conditions (the process data, the recipe parameters, and the like) by which the same effect is obtained in the change of the cross-sectional shapes between before and after processing.

Here, in the present embodiment, a group of the processing condition (the process data, the recipe parameters, and the like) by which the same effect is obtained in the change in the cross-sectional shapes between before and after processing is referred to as “Proxel” as a concept representing a minimum data unit in fine processing in the substrate manufacturing process. However, the “same effect” described here does not need that the changes in the cross-sectional shape are completely identical, and indicates that the changes in the cross-sectional shape are substantially identical (within a predetermined range).

The parameter deriving unit 121 reads multiple combinations of the pre-processing cross-sectional images and the post-processing cross-sectional images included in the simulation data of a specific Proxel among the simulation data classified for each Proxel.

Additionally, the parameter deriving unit 121 inputs multiple pre-processing cross-sectional images included in the read multiple combinations into the shape simulator 130 to acquire multiple predicted post-processing cross-sectional images from the shape simulator 130.

Here, when operating the shape simulator 130, the parameter deriving unit 121 repeatedly inputs the multiple pre-processing cross-sectional images into the shape simulator 130 while changing values of simulation parameter.

At this time, the parameter deriving unit 121 changes the values of the simulation parameter so that the multiple predicted post-processing cross-sectional images that are repeatedly output from the shape simulator 130 approach corresponding multiple post-processing cross-sectional images.

This allows the parameter deriving unit 121 to derive the optimum values of the simulation parameter that minimize the sum of respective difference values between the multiple predicted post-processing cross-sectional images and the corresponding multiple post-processing cross-sectional images. That is, according to the parameter deriving unit 121, a global optimum solution can be derived.

The shape simulator 130 operates in response to the pre-processing cross-sectional image and the values of the simulation parameter being input from the parameter deriving unit 121, and outputs the predicted post-processing cross-sectional image.

<Hardware Configuration of the Parameter Deriving Device>

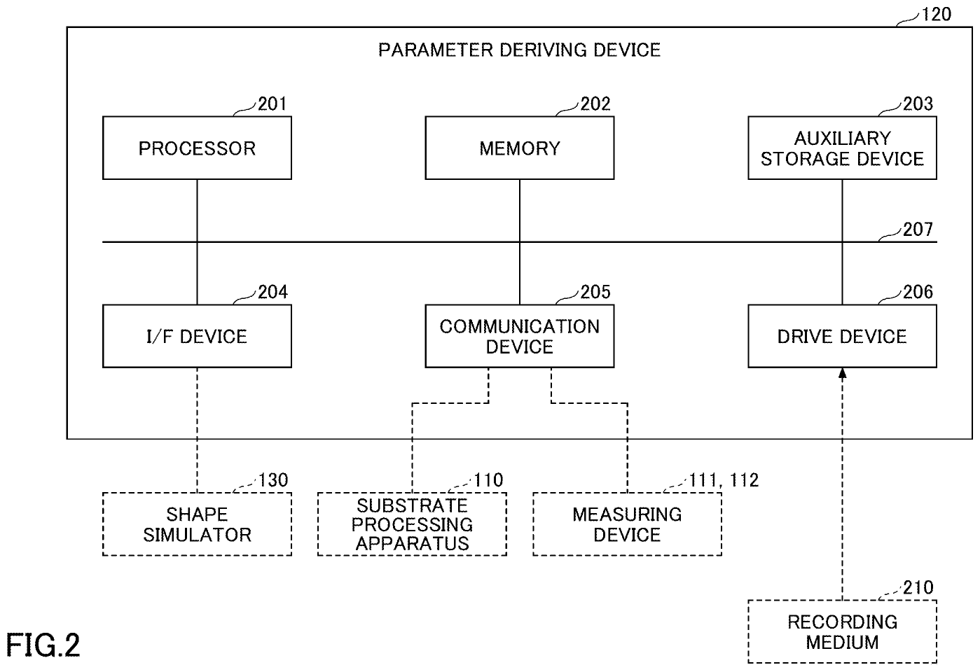

Next, a hardware configuration of the parameter deriving device 120 will be described. FIG. 2 is a diagram illustrating an example of the hardware configuration of the parameter deriving device.

As illustrated in FIG. 2, the parameter deriving device 120 includes a processor 201, a memory 202, an auxiliary storage device 203, an interface (I/F) device 204, a communication device 205, and a drive device 206. Here, hardware components of the parameter deriving device 120 are connected to each other via a bus 207.

The processor 201 includes various computing devices such as a central processing unit (CPU), a graphics processing unit (GPU), and the like. The processor 201 reads various programs (for example, the parameter deriving program and the like) on the memory 202 and executes the programs.

The memory 202 includes a main storage device such as a read only memory (ROM), a random access memory (RAM), and the like. The processor 201 and the memory 202 form what is called a computer, and the computer achieves various functions by the processor 201 executing various programs that are read on the memory 202.

The auxiliary storage device 203 stores various programs and various types of data used when the various programs are executed by the processor 201. The collection data storage unit 122 and the simulation data storage unit 123 described above are implemented in the auxiliary storage device 203.

The I/F device 204 is a connection device that connects the shape simulator 130, which is an example of an external device, and the parameter deriving device 120.

The communication device 205 is a communication device for communicating with the substrate processing apparatus 110, the measuring devices 111 and 112, and the like via a network.

The drive device 206 is a device for setting a recording medium 210. The recording medium 210 herein includes a medium optically, electrically, or magnetically recording information, such as a CD-ROM, a flexible disk, or a magneto-optical disk. Additionally, the recording medium 210 may include a semiconductor memory or the like that electrically records information, such as a ROM, a flash memory, or the like.

Here, the various programs installed in the auxiliary storage device 203 are installed by, for example, the distributed recording medium 210 being set in the drive device 206 and the various programs recorded in the recording medium 210 being read by the drive device 206. Alternatively, the various programs installed in the auxiliary storage device 203 may be installed by being downloaded from a network via the communication device 205.

<Specific Example of the Collection Data>

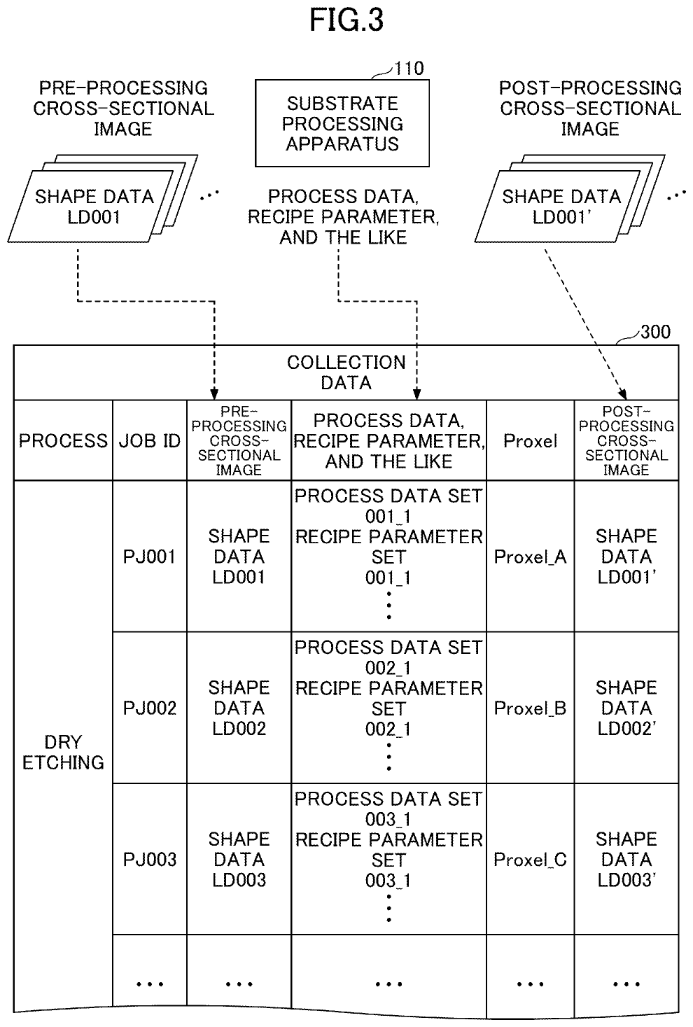

Next, a specific example of the collection data stored in the collection data storage unit 122 will be described. FIG. 3 is a diagram illustrating an example of the collection data stored in the collection data storage unit.

As illustrated in FIG. 3, collection data 300 includes “process”, “job ID”, “pre-processing cross-sectional image”, “process data, recipe parameters, and the like”, “Proxel”, and “post-processing cross-sectional image” as items of the information.

In the “process”, a name indicating the substrate manufacturing process is stored. The example of FIG. 3 indicates a state in which “dry etching” is stored as the “process”.

In “job ID”, an identifier for identifying a job executed by the substrate processing apparatus 110 is stored.

The example of FIG. 3 indicates a state in which “PJ001”, “PJ002”, and “PJ003” are stored as “job ID” of dry etching.

In “pre-processing cross-sectional image”, a file name of the pre-processing cross-sectional image generated by the measuring device 111 is stored. The example of FIG. 3 indicates that, in the case of job ID=“PJ001”, a pre-processing cross-sectional image having a file name=“shape data LD001” is generated by the measuring device 111 for one wafer before processing in a lot (a wafer group) of the job.

Additionally, the example of FIG. 3 indicates that, in the case of job ID=“PJ002”, a pre-processing cross-sectional image having a file name=“shape data LD002” is generated by the measuring device 111 for one wafer before processing in the lot (the wafer group) of the job. Further, the example of FIG. 3 indicates that, in the case of job ID=“PJ003”, a pre-processing cross-sectional image having a file name=“shape data LD003” is generated by the measuring device 111 for one wafer before processing in the lot (the wafer group) of the job.

In “process data, recipe parameters, and the like”, the processing condition (process data, recipe parameters, and the like) held when the wafer after processing is transferred in the substrate processing apparatus 110 is stored. In the example of FIG. 3, “process data set 001_1” and the like include, for example, the following process data:
data output from the substrate processing apparatus 110 during processing, such as Vpp (potential difference), Vdc (direct current self-bias voltage), OES (emission intensity by optical emission spectrometry), Reflect (reflected wave power), Top DCS current (detection value of a Doppler flowmeter), and the like; and
data measured during processing, such as Plasma density, Ion energy, Ion flux, and the like.

Additionally, in the example of FIG. 3, “recipe parameter set 001_1” and the like include, for example, the following recipe parameters:
data that is set as setting values in the substrate processing apparatus 110, such as Pressure (pressure in the chamber), Power (power of the high-frequency power source), Gas (gas flow rate), Temperature (temperature in the chamber or temperature of the surface of the wafer), and the like; and
data that is set as target values in the substrate processing apparatus 110, such as CD (critical dimension), Depth, Taper (taper angle), Tilting (tilt angle), Bowing, and the like.

In “Proxel”, a Proxel name indicating a group into which the process data (included in the process data set), the recipe parameters (included in the recipe parameter set), and the like stored in “process data, recipe parameters, and the like” are classified is stored. The example of FIG. 3 indicates that the process date, the recipe parameters, and the like corresponding to job ID=“PJ001” to “PJ003” are classified into “Proxel_A”, “Proxel_B”, and “Proxel_C”.

In “post processing cross-sectional image”, a file name of the post-processing cross-sectional image generated by the measuring device 112 is stored. The example of FIG. 3 indicates that, in the case of job ID=“PJ001”, a post-processing cross-sectional image having a file name=“shape data LD001′” is generated by the measuring device 112 for one wafer after processing in the lot (the wafer group) of the job.

Additionally, the example of FIG. 3 indicates that, in the case of job ID=“PJ002”, a post-processing cross-sectional image having a file name=“shape data LD002′” is generated by the measuring device 112 for one wafer after processing in the lot (the wafer group) of the job. Further, the example of FIG. 3 indicates that, in the case of job ID=“PJ003”, a post-processing cross-sectional image having a file name=“shape data LD003′” is generated by the measuring device 111 for one wafer after processing in the lot (wafer group) of the job.

<Functional Configuration of the Parameter Deriving Device>

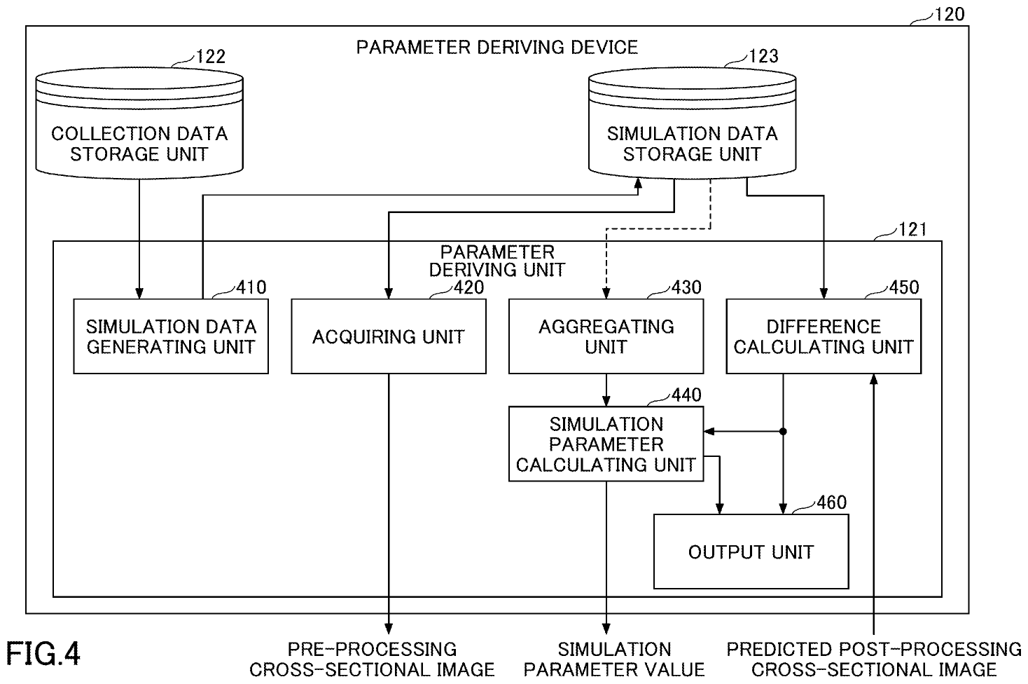

Next, a functional configuration of the parameter deriving device 120 will be described in detail. FIG. 4 is a first diagram illustrating an example of the functional configuration of the parameter deriving device. As illustrated in FIG. 4, the parameter deriving unit 121 of the parameter deriving device 120 includes the following:
a simulation data generating unit 410 (an example of a generating unit);
an acquiring unit 420;
an aggregating unit 430;
a simulation parameter calculating unit 440 (an example of a deriving unit);
a difference calculating unit 450; and
an output unit 460.

The simulation data generating unit 410 reads the collection data stored in the collection data storage unit 122, generates the simulation data, and then stores the generated simulation data in the simulation data storage unit 123. The simulation data generating unit 410 generates the simulation data for each identical Proxel.

The acquiring unit 420 reads, from the simulation data storage unit 123, multiple pre-processing cross-sectional images among multiple combinations of the pre-processing cross-sectional images and the post-processing cross-sectional images included in the simulation data of a specific Proxel.

Additionally, the acquiring unit 420 inputs the read multiple pre-processing cross-sectional images into the shape simulator 130 to operate the shape simulator 130.

The aggregating unit 430 generates a simulation parameter item to be input into the shape simulator 130 when the shape simulator 130 is operated using the simulation data of the specific Proxel. The aggregating unit 430 generates the simulation parameter item by referring to the item of the process data, the item of the recipe parameters, and the like included in the Proxel.

The simulation parameter calculating unit 440 calculates values of the simulation parameter to be input into the shape simulator 130. The simulation parameter calculating unit 440 first sets a predetermined initial value for each simulation parameter item generated by the aggregating unit 430 and inputs the values to the shape simulator 130.

Subsequently, the simulation parameter calculating unit 440 acquires respective difference values from the difference calculating unit 450. Then, the simulation parameter calculating unit 440 changes the values of the simulation parameter and inputs the changed values of the simulation parameter into the shape simulator 130 so that the sum of the acquired respective difference values is minimized.

Here, the simulation parameter calculating unit 440 repeats these processes until the sum of the respective difference values becomes minimum.

The difference calculating unit 450 acquires multiple predicted post-processing cross-sectional images output from the shape simulator 130 in response to the acquiring unit 420 inputting the multiple pre-processing cross-sectional images. Additionally, the difference calculating unit 450 reads corresponding multiple post-processing cross-sectional images from the simulation data storage unit 123, and calculates respective difference values with the multiple predicted post-processing cross-sectional images that are acquired.

Here, the difference calculating unit 450 extracts a feature from each of the multiple post-processing cross-sectional images and the multiple predicted post-processing cross-sectional images, and calculates a difference value between the extracted features. The difference value of the features herein includes, for example, any difference value among a difference value of the area, a difference value of the taper angle, a difference value of the depth, a difference value of the bowing, a difference value of the critical dimension, and the like.

Additionally, the difference calculating unit 450 notifies the simulation parameter calculating unit 440 of the calculated respective difference values (the number of the difference values corresponds to the number of the post-processing cross-sectional images and the predicted post-processing cross-sectional images).

The output unit 460 acquires the respective difference values from the difference calculating unit 450. Additionally, the output unit 460 acquires, from the simulation parameter calculating unit 440, the values of the simulation parameter when the sum of the acquired respective difference values is minimized. Further, the output unit 460 outputs the values of the simulation parameter acquired from the simulation parameter calculating unit 440 as the optimum values of the simulation parameter.

<Specific Example of Processing of Each Unit of the Parameter Deriving Device>

Next, a specific example of processing of each unit (here, the simulation data generating unit 410, the aggregating unit 430, the simulation parameter calculating unit 440, and the difference calculating unit 450) of the parameter deriving device 120 will be described.

(1) Specific Example of Processing of the Simulation Data Generating Unit

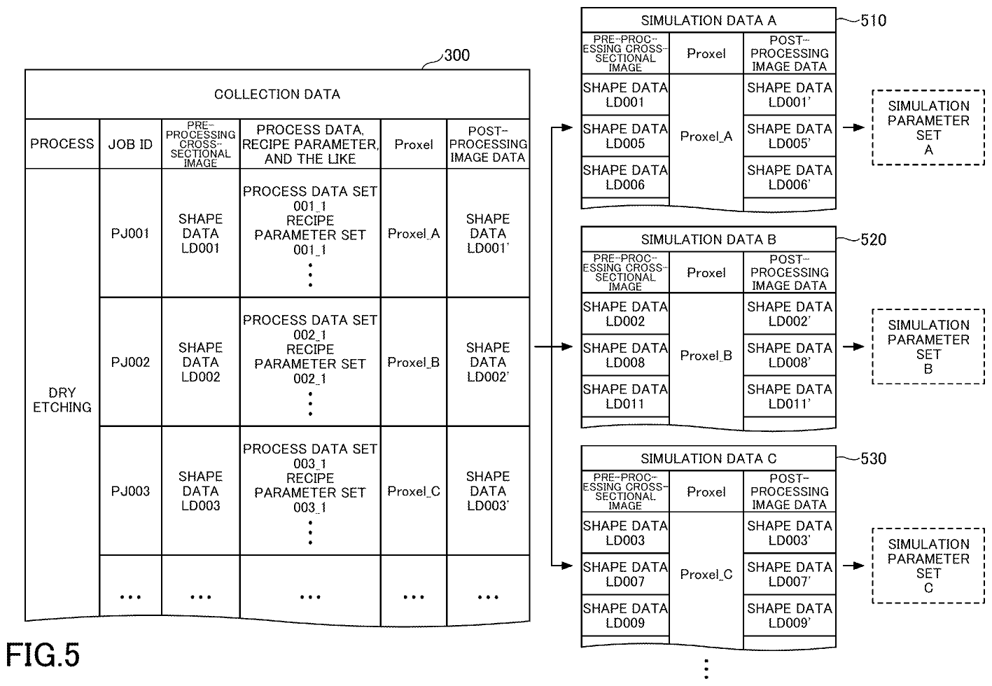

First, a specific example of processing of the simulation data generating unit 410 will be described. FIG. 5 is a diagram illustrating a specific example of processing of the simulation data generating unit.

As illustrated in FIG. 5, the simulation data generating unit 410 reads the collection data 300 from the collection data storage unit 122, and generates the simulation data for each Proxel.

The example of FIG. 5 indicates a state in which, based on the collection data 300, the simulation data generating unit 410 generates:
simulation data 510 (data name=“simulation data A”);
simulation data 520 (data name=“simulation data B”); and
simulation data 530 (data name=“simulation data C”).

In the example of FIG. 5, the simulation data 510 is simulation data including combinations corresponding to the Proxel name=“Proxel_A” among the multiple combinations included in the collection data 300.

Similarly, in the example of FIG. 5, the simulation data 520 is simulation data including combinations corresponding to the Proxel name=“Proxel_B” among the multiple combinations included in the collection data 300.

Similarly, in the example of FIG. 5, the simulation data 530 is simulation data including combinations corresponding to the Proxel name=“Proxel_C” among the multiple combinations included in the collection data 300.

Here, as described above, the parameter deriving unit 121 derives the optimum values of the simulation parameter, using the simulation data for each Proxel. The example of FIG. 5 indicates:
the optimal values of the simulation parameter are derived using the simulation data 510 and a simulation parameter set A is output;
the optimal values of the simulation parameter are derived using the simulation data 520 and a simulation parameter set B is output; and
the optimal values of the simulation parameter are derived using the simulation data 530 and a simulation parameter set C is output.

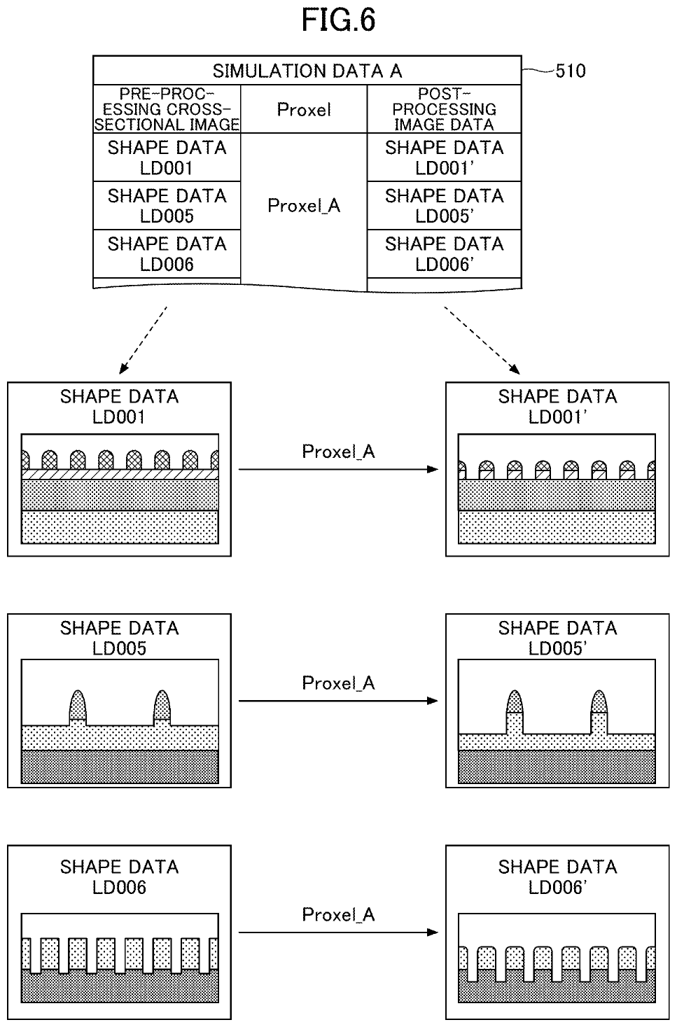

Subsequently, a specific example of the simulation data will be described. FIG. 6 is a diagram illustrating a specific example of the simulation data stored in the simulation data storage unit.

In FIG. 6, the pre-processing cross-sectional images illustrated on the left side of the drawing sheet are pre-processing cross-sectional images having file names “shape data LD001”, “shape data LD005”, and “shape data LD006”. With respect to the above, in FIG. 6, the post-processing cross-sectional images illustrated on the right side of the drawing sheet are post-processing cross-sectional images having the file names=“shape data LD001′”, “shape data LD005′”, and “shape data LD006′”.

As described above, the common simulation parameter set A including the optimum values of the simulation parameter is output for the multiple combinations of the pre-processing cross-sectional images and the post-processing cross-sectional images included in the simulation data 510. The simulation data generating unit 410 generates the simulation data 510 using cross-sectional images having different cross-sectional shapes so that the simulation parameter set A that is output at this time becomes a more global optimum solution.

Specifically, the simulation data 510 is configured such that the pre-processing cross-sectional image included in any one combination has a cross-sectional shape different from that of the pre-processing cross-sectional image included in any other combination (see the left side of the drawing sheet of FIG. 6). Additionally, the simulation data 510 is configured such that the post-processing cross-sectional image included in any one combination has a cross-sectional shape different from that of the post-processing cross-sectional image included in any other combination (see the right side of the drawing sheet of FIG. 6).

In other words, the simulation data for each Proxel includes a combination in which the cross-sectional shape before or after processing is different from the cross-sectional shapes before or after processing of the other combinations.

Here, “cross-sectional shapes are different” includes:
the aspect ratios are different from each other,
the mask shapes are different from each other,
the types of films and relative positions thereof are different from each other,
the surface states are different from each other, or
the surrounding aperture ratios are different from each other.

As described above, the parameter deriving unit 121 does not derive the optimum simulation parameter by simply using multiple combinations but rather derives the optimum simulation parameter by using multiple combinations having cross-sectional shapes different from each other. As a result, the parameter deriving unit 121 can derive a more global optimal solution.

Here, FIG. 6 illustrates an example in which both the pre-processing cross-sectional image and the post-processing cross-sectional image have cross-sectional shapes different from each other. However, either the pre-processing cross-sectional image or the post-processing cross-sectional image may have a cross-sectional shape different from each other.

(2) Specific Example of Processing of the Aggregating Unit

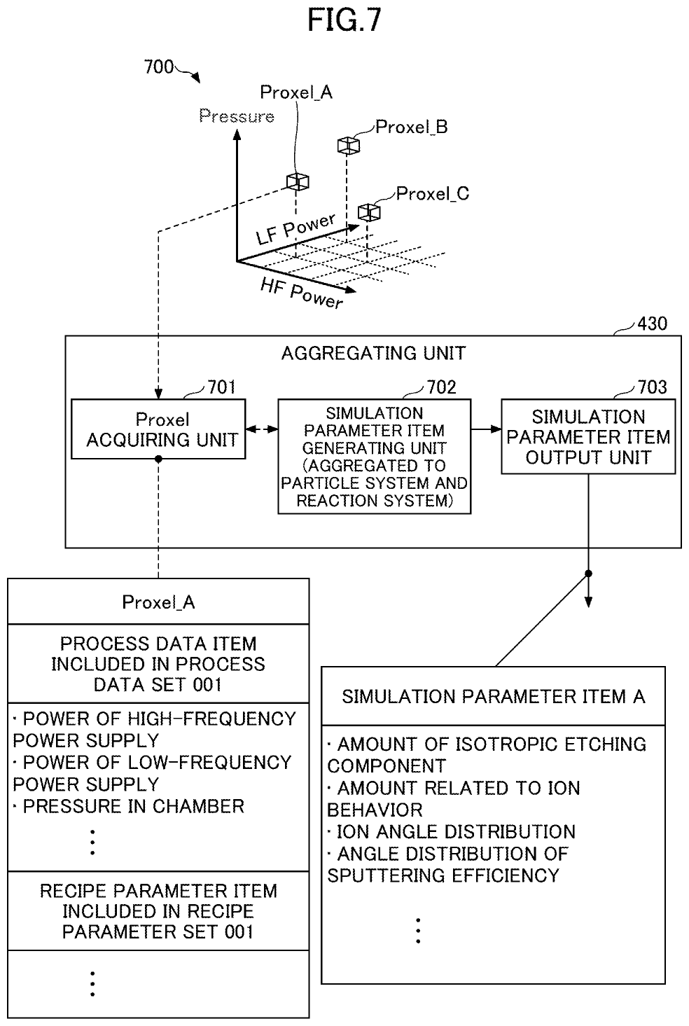

Next, a specific example of processing of the aggregating unit 430 will be described. FIG. 7 is a diagram illustrating the specific example of the processing of the aggregating unit.

As illustrated in FIG. 7, the aggregating unit 430 includes a Proxel acquiring unit 701, a simulation parameter item generating unit 702, and a simulation parameter item output unit 703.

The Proxel acquiring unit 701 acquires a process data item and a recipe parameter item forming Proxel corresponding to specific simulation data among the simulation data stored in the simulation data storage unit 123.

As indicated by the reference numeral 700 in FIG. 7, Proxel_A to Proxel_C are generated by partitioning a multidimensional space including process data items, recipe parameter items, and the like into small spaces by plots having the same effect. An example indicated by the reference numeral 700 in FIG. 7 illustrates a small space of each Proxel generated by partitioning a three dimensional space including the power of the high-frequency power supply, the power of the low-frequency power supply, and the pressure in the chamber.

When deriving the values of the optimum simulation parameter using the simulation data of Proxel_A, the Proxel acquiring unit 701 acquires the following data and the like forming Proxel_A.
A process data item and value (included in the process data set 001)
A recipe parameter item and value (included in the recipe parameter set 001)

The example of FIG. 7 illustrates a state in which the Proxel acquiring unit 701 acquires the power of the high-frequency power supply, the power of the low-frequency power supply, and the pressure in the chamber.

The simulation parameter item generating unit 702 generates a simulation parameter item A of the shape simulator 130 by referring to the process data item and value and the recipe parameter item and value acquired by the Proxel acquiring unit 701. The simulation parameter item generating unit 702 generates the item A by the simulation parameter being separated into the simulation parameter of the particle system and the simulation parameter of the reaction system, for example. Here, when the simulation parameter item generating unit 702 generates the simulation parameter item, domain knowledge may be reflected.

The example of FIG. 7 indicates that the amount of an isotropic etching component and the like are generated as the simulation parameter item of the particle system. Additionally, it is indicated that the amount related to ion behavior, the ion angle distribution, the angle distribution of sputtering efficiency, and the like are generated as the items of the simulation parameter of the reaction system.

As described above, the simulation parameter item generating unit 702 generates the simulation parameter item A by abstracting the process data items, the recipe parameter items, and the like forming Proxel into categories of the reaction elements having no overlap as the physical phenomenon. This allows the simulation parameter item generating unit 702 to generate the simulation parameter item A with the number of dimensions being reduced.

The simulation parameter item output unit 703 outputs the simulation parameter item A generated by the simulation parameter item generating unit 702 to the simulation parameter calculating unit 440.

(3) Specific Example of Processing of the Simulation Parameter Calculating Unit

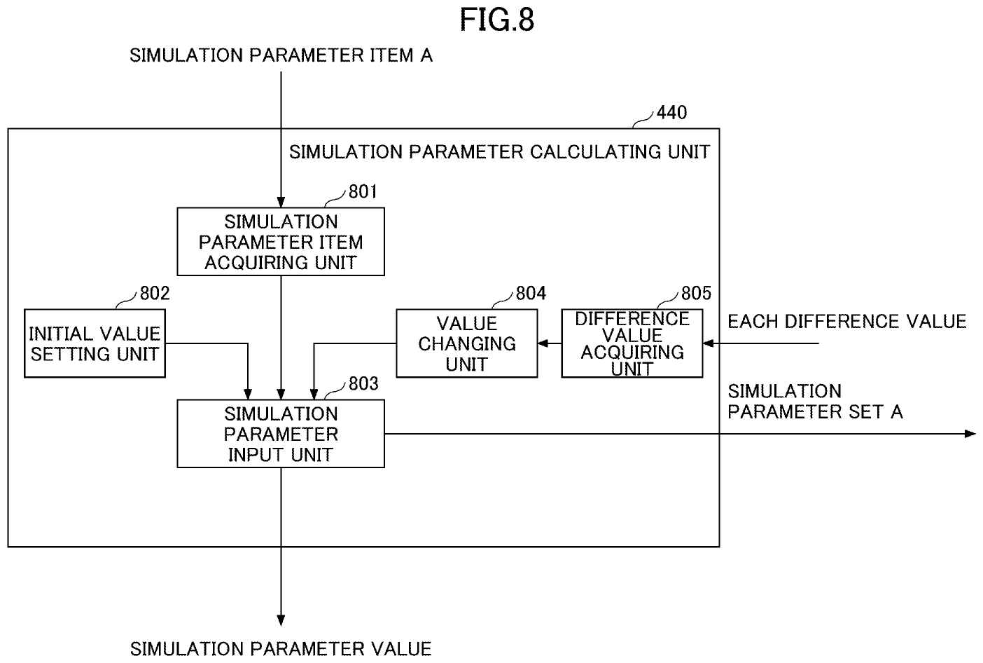

Next, a specific example of processing of the simulation parameter calculating unit 440 will be described. FIG. 8 is a first diagram illustrating the specific example of the processing of the simulation parameter calculating unit.

As illustrated in FIG. 8, the simulation parameter calculating unit 440 includes a simulation parameter item acquiring unit 801, an initial value setting unit 802, a simulation parameter input unit 803, a value changing unit 804, and a difference value acquiring unit 805.

The simulation parameter item acquiring unit 801 acquires the simulation parameter item (for example, the “simulation parameter item A”) from the aggregating unit 430, and sets the simulation parameter item in the simulation parameter input unit 803.

The initial value setting unit 802 sets an initial value corresponding to each simulation parameter item in the simulation parameter input unit 803.

The simulation parameter input unit 803 inputs a value of simulation parameter when multiple pre-processing cross-sectional images are input into the shape simulator 130. The simulation parameter input unit 803 first inputs the initial value, and thereafter inputs a value to which the value of the simulation parameter is instructed to be changed by the value changing unit 804.

Additionally, the simulation parameter input unit 803 outputs, to the output unit 460, a simulation parameter set (here, the “simulation parameter set A”) including optimum simulation parameter values that minimize the sum of the respective difference values.

The value changing unit 804 instructs the simulation parameter input unit 803 to change the value of the simulation parameter. Specifically, every time the sum of the respective difference values is provided by notification by the difference value acquiring unit 805, the value changing unit 804 gives a change instruction in accordance with the provided sum of the difference values to the simulation parameter input unit 803. Here, the value changing unit 804 gives change instructions, the number of the change instructions being determined in accordance with the number of the simulation parameter items, to the simulation parameter input unit 803. Here, the change instruction given by the value changing unit 804 includes a change direction (an increase or decrease) and a change amount.

This allows the simulation parameter input unit 803 to input a value of the simulation parameter in accordance with the sum of the respective difference values into the shape simulator 130.

The difference value acquiring unit 805 acquires each difference value provided by notification by the difference calculating unit 450. The difference value acquiring unit 805 acquires the respective difference values, the number of the difference values being determined in accordance with the number of pre-processing cross-sectional images that is input into the shape simulator 130.

Additionally, the difference value acquiring unit 805 calculates the sum of the acquired respective difference values and compares the sum with the sum of the previously acquired respective difference values to determine whether the sum of the respective difference values has increased or decreased. Additionally, the difference value acquiring unit 805 notifies the value changing unit 804 of the calculated sum of the respective difference values and the determination result. This allows the value changing unit 804 to determine the change instruction (including the change direction and the change amount) of each value of the simulation parameter.

(4) Specific Example of Processing of the Difference Calculating Unit

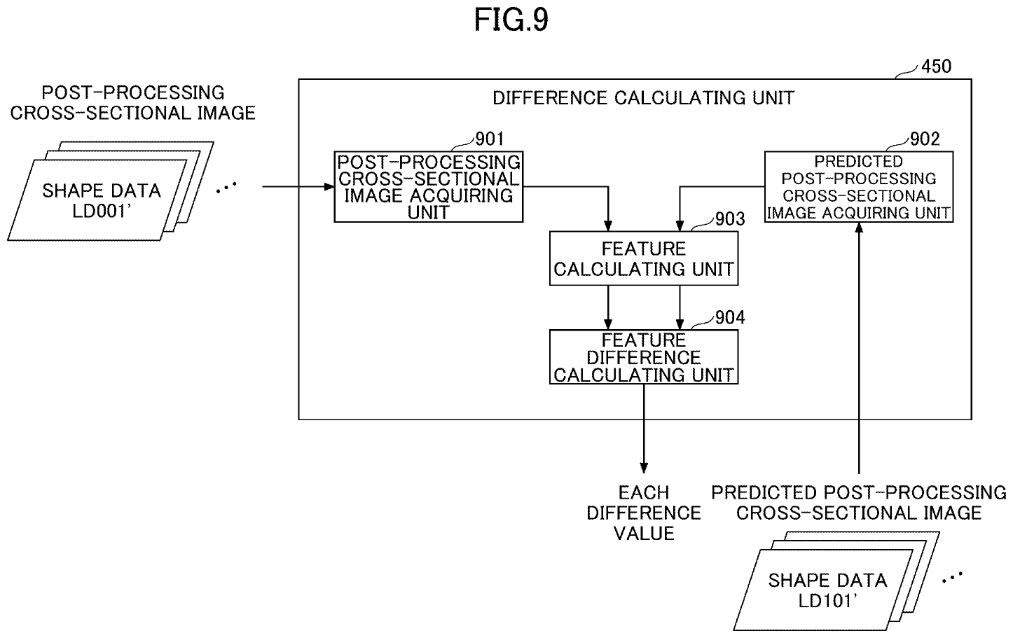

Next, a specific example of processing of the difference calculating unit 450 will be described. FIG. 9 is a diagram illustrating the specific example of the processing of the difference calculating unit.

As illustrated in FIG. 9, the difference calculating unit 450 includes a post-processing cross-sectional image acquiring unit 901, a predicted post-processing cross-sectional image acquiring unit 902, a feature calculating unit 903, and a feature difference calculating unit 904.

The post-processing cross-sectional image acquiring unit 901 acquires post-processing cross-sectional images (for example, shape data LD001′, LD005′, and LD006′) corresponding to multiple pre-processing cross-sectional images (for example, shape data LD001, LD005, and LD006) to be input into the shape simulator 130. Additionally, the post-processing cross-sectional image acquiring unit 901 notifies the feature calculating unit 903 of the acquired post-processing cross-sectional images.

The predicted post-processing cross-sectional image acquiring unit 902 acquires multiple predicted post-processing cross-sectional images (for example, LD101′, LD105′, and LD106′) in response to the multiple pre-processing cross-sectional images (for example, shape data LD001, LD005, and LD006) being input. Additionally, the predicted post-processing cross-sectional image acquiring unit 902 notifies the feature calculating unit 903 of the acquired predicted post-processing cross-sectional images.

The feature calculating unit 903 extracts features from the post-processing cross-sectional images provided by notification by the post-processing cross-sectional image acquiring unit 901. Additionally, the feature calculating unit 903 extracts features from the predicted post-processing cross-sectional images provided by notification by the predicted post-processing cross-sectional image acquiring unit 902. Here, the features extracted by the feature calculating unit 903 include, for example, the area of a cross-section, the taper angle, the depth, the bowing, the critical dimension, and the like.

The feature calculating unit 903 notifies the feature difference calculating unit 904 of the features extracted from the post-processing cross-sectional images and the features extracted from the predicted post-processing cross-sectional images.

The feature difference calculating unit 904 calculates difference values between the features extracted from the post-processing cross-sectional images and the features extracted from the predicted post-processing cross-sectional images, and notifies the simulation parameter calculating unit 440 of the calculated difference values. The feature difference calculating unit 904 calculates the difference values, the number of which corresponds to the number of the pre-processing cross-sectional images input into the shape simulator 130, and notifies the simulation parameter calculating unit 440 of the calculated difference values.

<Simulation Parameter Deriving Process>

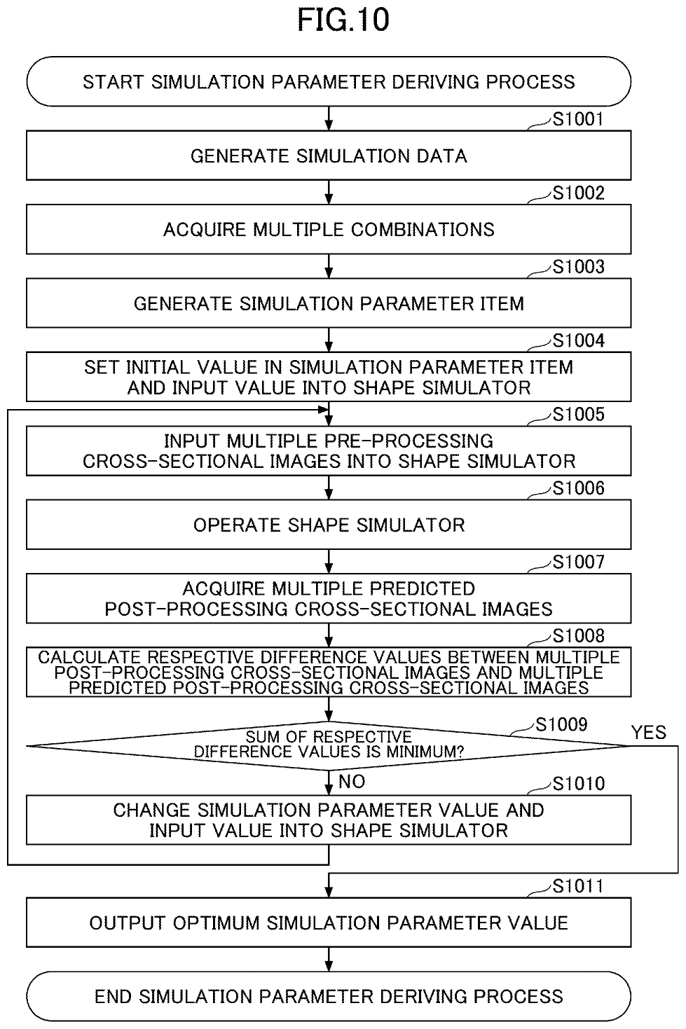

Next, a flow of a simulation parameter deriving process performed by the parameter deriving device 120 will be described. FIG. 10 is a first flowchart illustrating the flow of the simulation parameter deriving process.

In step S1001, the parameter deriving device 120 reads the collection data and generates the simulation data.

In step S1002, the parameter deriving device 120 acquires multiple combinations of the pre-processing cross-sectional images and the post-processing cross-sectional images included in the simulation data of the specific Proxel.

In step S1003, the parameter deriving device 120 refers to the process data item and value, the recipe parameter item and value, and the like forming the specific Proxel to generate the simulation parameter item.

In step S1004, the parameter deriving device 120 sets an initial value in the simulation parameter item and inputs the value into the shape simulator 130.

In step S1005, the parameter deriving device 120 inputs multiple pre-processing cross-sectional images included in the multiple combinations into the shape simulator 130.

In step S1006, the parameter deriving device 120 operates the shape simulator 130.

In step S1007, the parameter deriving device 120 acquires multiple predicted post-processing cross-sectional images from the shape simulator 130.

In step S1008, the parameter deriving device 120 calculates respective difference values between the multiple post-processing cross-sectional images included in the multiple combinations and the multiple predicted post-processing cross-sectional images.

In step S1009, the parameter deriving device 120 determines whether the sum of the respective difference values has become minimum.

When it is determined in step S1009 that the sum of the respective difference values is not minimum (NO in step S1009), the process proceeds to step S1010.

In step S1010, the parameter deriving device 120 changes the value of the simulation parameter, inputs the changed value of the simulation parameter into the shape simulator 130, and then returns to step S1005.

When it is determined in step S1009 that the sum of the respective difference values has become minimum (YES in step S1009), the process proceeds to step S1011.

In step S1011, the parameter deriving device 120 outputs optimum values of the simulation parameter that minimize the sum of the respective difference values.

### SUMMARY

As is apparent from the above description, the parameter deriving device 120 according to the first embodiment includes:
generating multiple combinations of pre-processing cross-sectional images and post-processing cross-sectional images of substrates, processed under the same Proxel, in which either a pre-processing or post-processing cross-sectional shape is different from a pre-processing or post-processing cross-sectional shape of another combination; and
deriving a value of a simulation parameter that minimizes the sum of difference values between predicted post-processing cross-sectional images predicted by inputting the respective pre-processing cross-sectional images included in the multiple combinations into a shape simulator; and corresponding post-processing cross-sectional images.

As described above, by adopting a configuration in which common values of the simulation parameter are derived from the multiple combinations having the cross-sectional shapes different from each other, the parameter deriving device 120 according to the first embodiment can derive a global optimum solution.

### Second Embodiment

In the first embodiment above, the value of the simulation parameter to be input into the shape simulator 130 is suitably changed. With respect to the above, in a second embodiment, the value is changed under a predetermined constraint condition.

With this, according to the second embodiment, the number of the operations of the shape simulator 130 can be reduced in deriving the optimum values of the simulation parameter. In the following, with respect to the second embodiment, points different from the first embodiment will be mainly described.

<Functional Configuration of a Parameter Deriving Device>

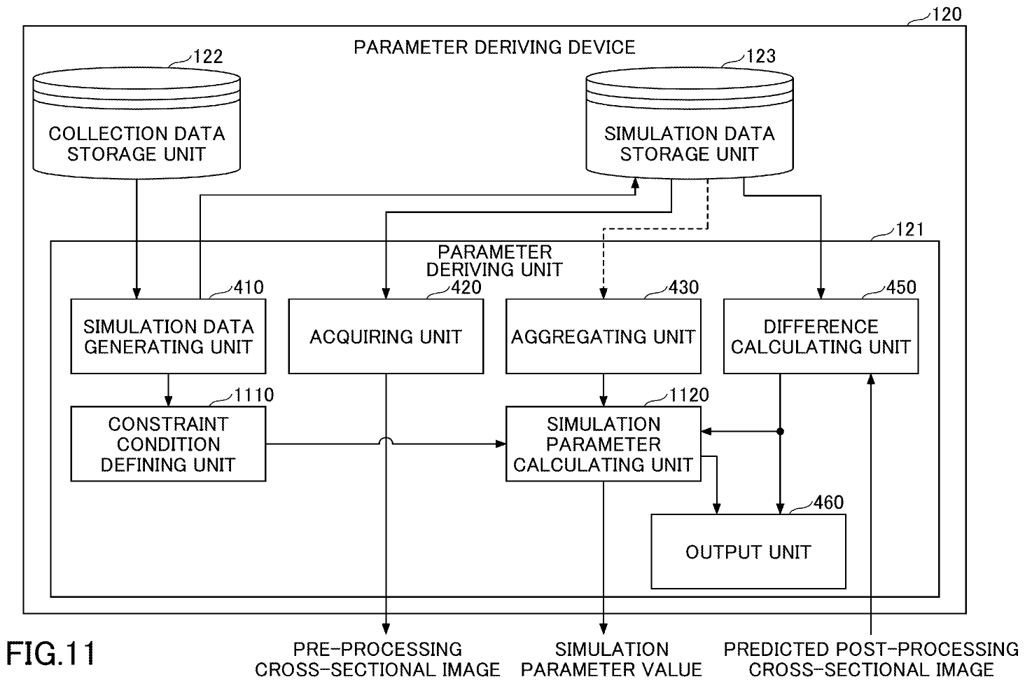

First, a functional configuration of a parameter deriving device according to the second embodiment will be described. FIG. 11 is a second diagram illustrating an example of the functional configuration of the parameter deriving device.

The point different from the parameter deriving device 120 illustrated in FIG. 4 is that, in FIG. 11, a constraint condition defining unit 1110 is included and the function of a simulation parameter calculating unit 1120 is different from the function of the simulation parameter calculating unit 440.

The constraint condition defining unit 1110 defines a constraint condition used when the simulation parameter calculating unit 1120 changes the value of the simulation parameter.

Specifically, the constraint condition defining unit 1110 defines the constraint condition based on the value of the process data, the value of the recipe parameter, and the like forming Proxel. The constraint condition herein indicates a sharing relationship, a hierarchical relationship, a ratio relationship, or the like between the following:
a value of the simulation parameter changed when the optimum simulation parameter is derived for multiple combinations of the pre-processing cross-sectional images and the post-processing cross-sectional images included in the simulation data of a specific Proxel; and
a value of the simulation parameter changed when the optimum simulation parameter is derived for multiple combinations of the pre-processing cross-sectional images and the post-processing cross-sectional images included in the simulation data of another Proxel.

The simulation parameter calculating unit 1120 calculates the value of the simulation parameter to be input into the shape simulator 130. The simulation parameter calculating unit 1120 first sets an initial value in accordance with the constraint condition defined by the constraint condition defining unit 1110 and inputs the value into the shape simulator 130.

Subsequently, the simulation parameter calculating unit 1120 acquires each difference value from the difference calculating unit 450. Then, the simulation parameter calculating unit 1120 changes the value of the simulation parameter so that the sum of the acquired respective difference values is minimized. At this time, the simulation parameter calculating unit 1120 changes the value of the simulation parameter under the constraint condition defined by the constraint condition defining unit 1110, and inputs the changed value of the simulation parameter into the shape simulator 130.

Here, the simulation parameter calculating unit 1120 repeats these types of processing until the sum of the respective difference values becomes minimum.

<Specific Example of Processing of Each Unit of the Parameter Deriving Device>

Next, a specific example of processing of each unit (here, the constraint condition defining unit 1110 and the simulation parameter calculating unit 1120) of the parameter deriving device 120 according to the second embodiment will be described.

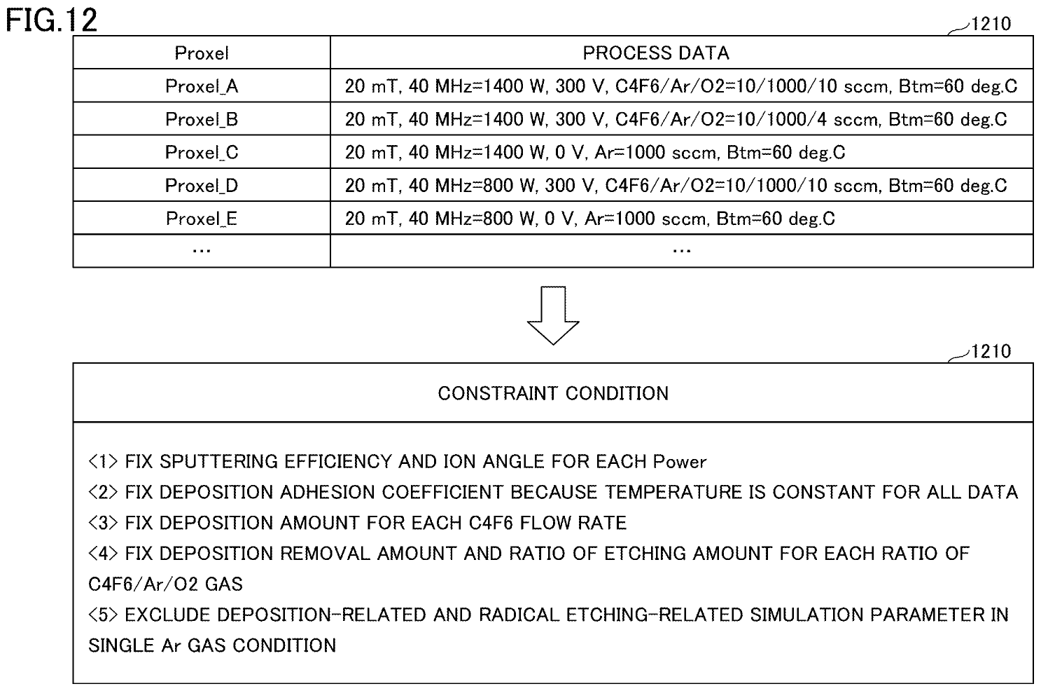

(1) Specific example of the processing of the constraint condition defining unit First, a specific example of the processing of the constraint condition defining unit 1110 will be described. FIG. 12 is a diagram illustrating a specific example of the processing of the constraint definition unit.

Here, the reference numeral 1210 in FIG. 12 indicates specific values of the respective process data included in “Proxel_A” to “Proxel_E”. In the case of the values of the process data included in each Proxel indicated by the reference numeral 1210, the constraint condition defining unit 1110 defines, for example, the following constraint conditions (the reference numeral 1220).
The sputtering efficiency and the ion angle of the simulation parameter are fixed for each Power (Constraint condition <I>)
The deposition adhesion coefficient of the simulation parameter is fixed because the temperature is constant (Constant constraint <2>).
The deposition amount of the simulation parameter is fixed for each flow rate of C4F6 (Constraint condition <3>).
The deposition removal amount and the ratio of the etching amount of the simulation parameter is fixed for each ratio of C4F6/Ar/O2 gas (Constraint condition 4>).
The deposition-related parameter and the radical etching-related parameter of the simulation parameter are excluded in the case of the Ar single gas condition (Constraint condition 5>).

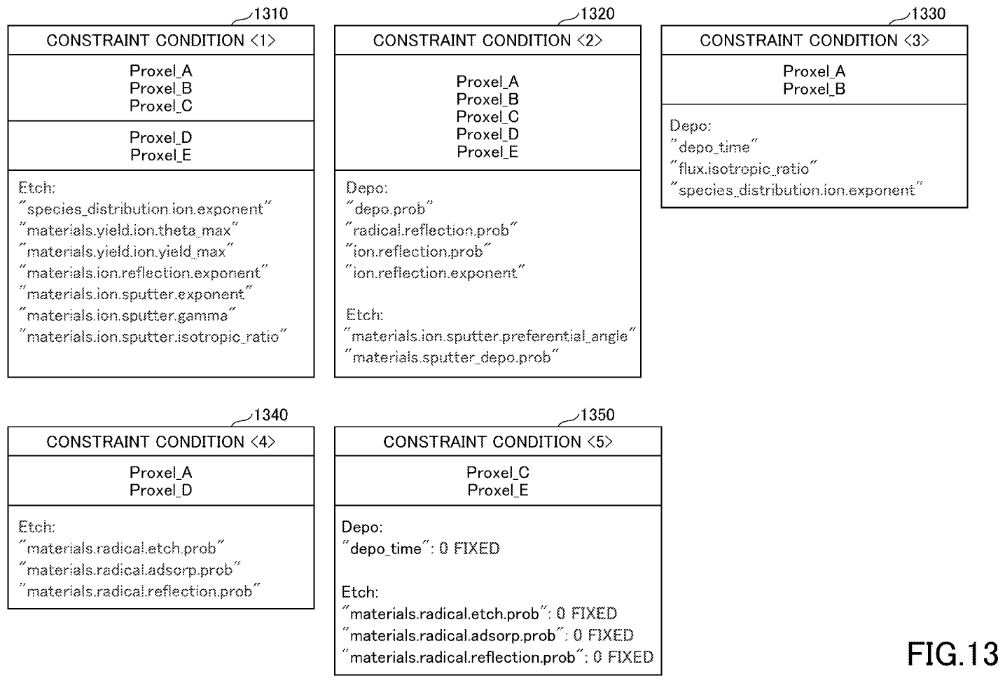

Next, a specific example of the constraint condition (the reference numeral 1220) will be described. FIG. 13 is a diagram illustrating the specific examples of the constraint condition.

Here, the reference numeral 1310 is a specific example of Constraint condition <1>, and indicates:
for the simulation data of Proxel_A, Proxel_B, and Proxel_C including process data of Power=40 MHz and 1400 W, the sputtering efficiency and the ion angle are fixed when the optimum simulation parameter is to be derived; and
for simulation data of Proxel D and Proxel_E including process data of Power=40 MHz and 800 W, the sputtering efficiency and the ion angle are fixed when the optimum simulation parameter is to be derived.

Additionally, the reference numeral 1320 is a specific example of Constraint condition <2>, and indicates:
for the simulation data of Proxel_A to Proxel_E including process data having the same temperature, the deposit adhesion coefficient is fixed when the optimum simulation parameter is to be derived.

Additionally, the reference numeral 1330 is a specific example of Constraint condition <3>, and indicates:
for the simulation data of Proxel_A and Proxel_B including process data: the flow rate of C4F6=10 sccm, the deposit amount is common when the optimum simulation parameter is to be derived.

Additionally, the reference numeral 1350 is a specific example of Constraint condition <4>, and indicates:
for the simulation data of Proxel_A and Proxel D including process data having the identical ratio of C4F6/Ar/O2 gas, the deposition removal amount and the ratio of the etching amount is fixed when the optimum simulation parameter is to be derived.

Additionally, the reference numeral 1340 is a specific example of Constraint condition <5>, and indicates:
for the simulation data of Proxel_C and Proxel_E including process data of the Ar single gas condition, the values of the deposition-related simulation parameter and etching-related simulation parameter are fixed to “0” when the optimum simulation parameter is to be derived.

(2) Specific Example of Processing of the Simulation Parameter Calculating Unit

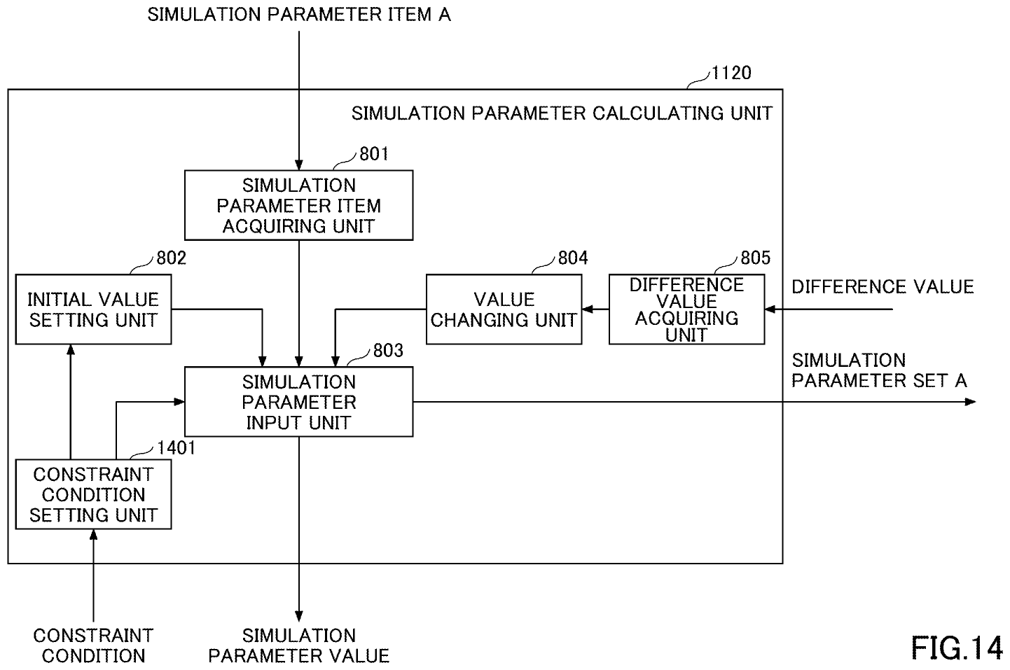

Next, a specific example of processing of the simulation parameter calculating unit 1120 will be described. FIG. 14 is a second diagram illustrating a specific example of the processing of the simulation parameter calculating unit.

The point different from the simulation parameter calculating unit 440 illustrated in FIG. 8 is that the simulation parameter calculating unit 1120 illustrated in FIG. 14 includes a constraint condition setting unit 1401.

When acquiring the constraint condition from the constraint condition defining unit 1110, the constraint condition setting unit 1401 sets the acquired constraint condition in the initial value setting unit 802 and the simulation parameter input unit 803.

This allows the initial value setting unit 802 to set an initial value in accordance with the constraint condition in the simulation parameter input unit 803. Additionally, the simulation parameter input unit 803 can input a simulation parameter changed under the constraint condition into the shape simulator 130.

<Simulation Parameter Deriving Process>

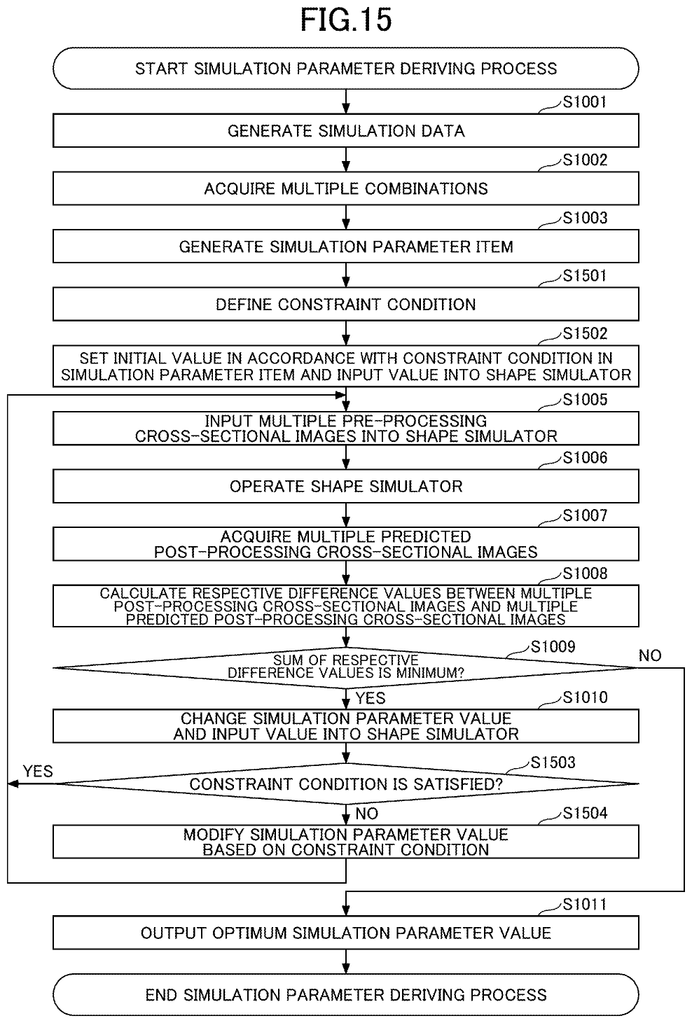

Next, a flow of a simulation parameter deriving process performed by the parameter deriving device 120 according to the second embodiment will be described. FIG. 15 is a second flowchart illustrating the flow of the simulation parameter deriving process. The points different from the flowchart illustrated in FIG. 10 are steps S1501 to S1502 and steps S1503 to S1504.

In step S1501, the parameter deriving device 120 defines the constraint condition based on the process parameter value, the recipe parameter value, and the like included in Proxel.

In step S1502, the parameter deriving device 120 sets the initial value in accordance with the constraint condition in the item of the simulation parameter and inputs the value into the shape simulator 130.

In step S1503, the parameter deriving device 120 determines whether the changed value of the simulation parameter that is changed in step S1010 satisfies the constraint condition.

When it is determined in step S1503 that the constraint condition is satisfied (YES in step S1503), the process returns to step S1005.

When it is determined in step S1503 that the constraint condition is not satisfied (YES in step S1503), the process proceeds to step S1504.

In step S1504, the parameter deriving device 120 modifies the changed value of the simulation parameter that is changed in step S1010, based on the constraint condition, inputs the value into the shape simulator 130, and then returns to step S1005.

### SUMMARY

As is apparent from the above description, the parameter deriving device according to the second embodiment changes the value of the simulation parameter to be input into the shape simulator under the predetermined constraint condition when deriving the optimum values of the simulation parameter.

With this, according to the second embodiment, the number of the operations of the shape simulator can be reduced in deriving the optimum values of the simulation parameter.

### Third Embodiment

Although a method of changing the value of the simulation parameter has not been described in the first embodiment, the simulation parameter calculating unit may be configured to change the value of the simulation parameter based on the design of experiments, for example. In the following, with respect to a third embodiment, points different from the first and second embodiments will be described.

<Specific Example of Processing of the Simulation Parameter Calculating Unit>

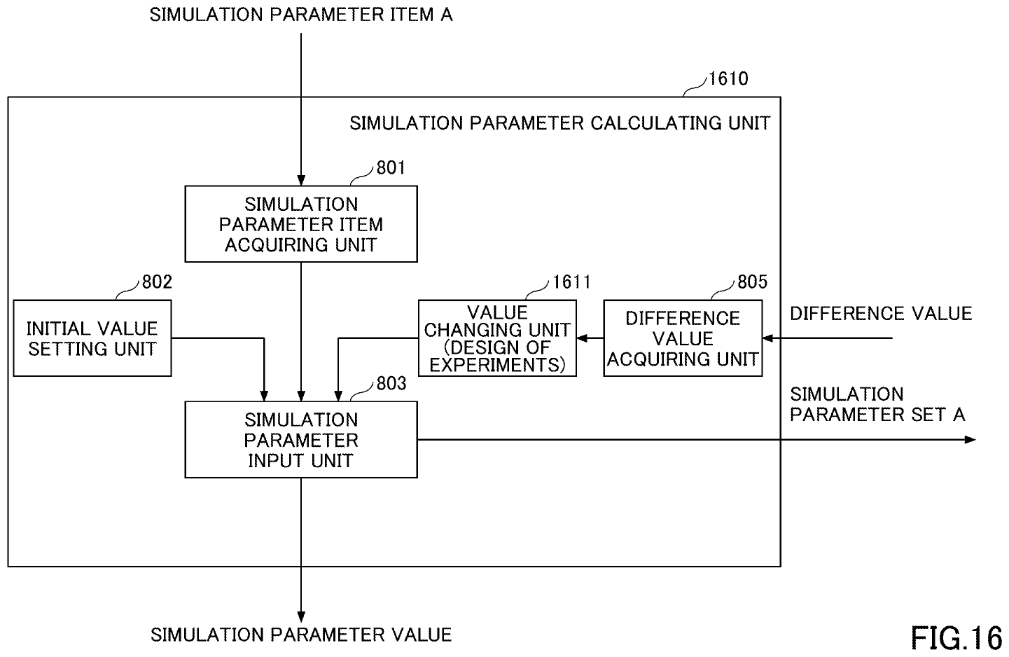

First, a specific example of processing of the simulation parameter calculating unit will be described. FIG. 16 is a third diagram illustrating the specific example of the processing of the simulation parameter calculating unit.

A point different from the simulation parameter calculating unit 440 illustrated in FIG. 8 is that in a simulation parameter calculating unit 1610 illustrated in FIG. 16, a function of a value changing unit 1611 is different from the function of the value changing unit 804 illustrated in FIG. 8.

When changing the value of each item of the simulation parameter, the value changing unit 1611 simultaneously changes values of multiple items based on the design of experiments. With this, according to the value changing unit 1611, the number of the operations of the shape simulator can be reduced in deriving the optimum values of the simulation parameter.

<Outline of the Design of Experiments>

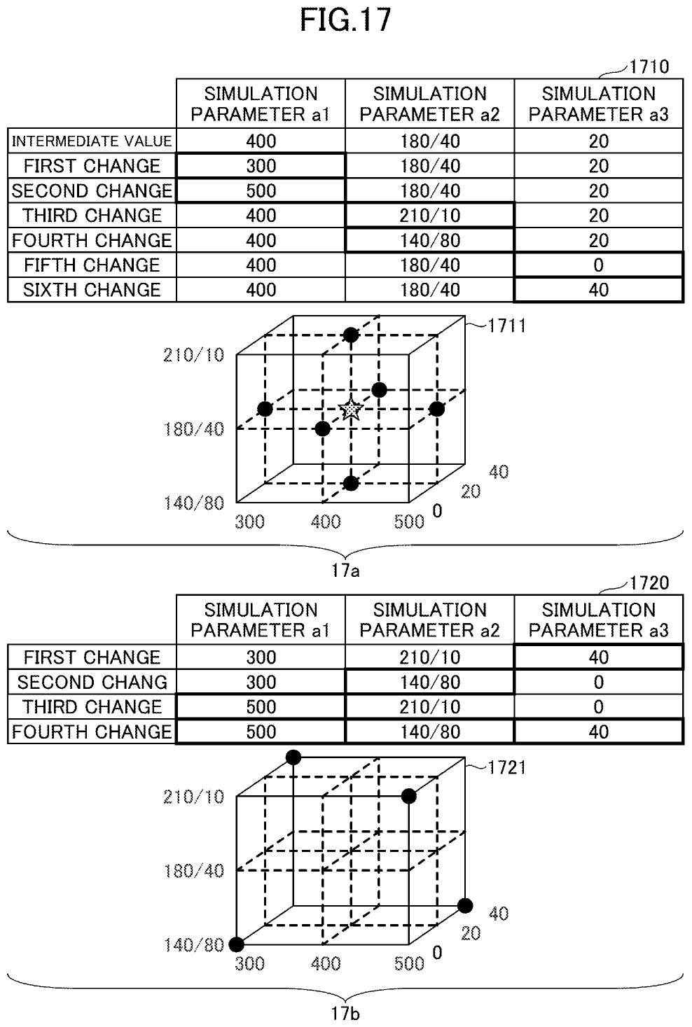

Next, an outline of the design of experiments used by the value changing unit 1611 will be described. FIG. 17 is a diagram for explaining the outline of the design of experiments.

Here, 17a of FIG. 17 is a diagram schematically illustrating a changing method of sequentially changing the value of each item of the simulation parameter as a comparative example. In 17a in FIG. 17, among multiple items of the simulation parameter, the number of items of the simulation parameter whose values are changed at one time is limited to one (see the thick line frame of the reference numeral 1710). Therefore, the values of the simulation parameter at six points in the space 1711 are input into the shape simulator 130.

With respect to the above, 17b of FIG. 17 is a diagram schematically illustrating a changing method for changing the value of each item of the simulation parameter based on the design of experiments. In 17b in FIG. 17, among multiple items of the simulation parameter, multiple values of the simulation parameter can be changed at one time (see the thick line frame of reference numeral 1720). As a result, the values of the simulation parameter at four points in the space 1721 are input into the shape simulator 130.

As described above, by using the design of experiments, the number of changes of the simulation parameter required until the optimum values of the simulation parameter are reached can be reduced. As a result, the number of the operations of the shape simulator can be reduced.

<Simulation Parameter Deriving Process>

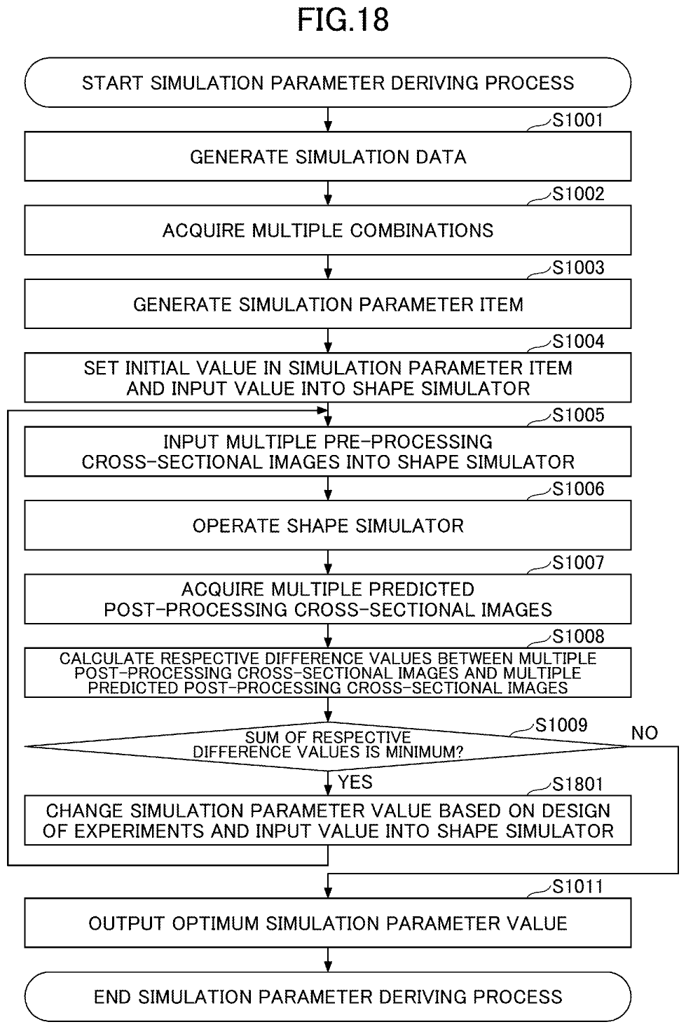

Next, a flow of a simulation parameter deriving process performed by the parameter deriving device 120 according to the third embodiment will be described. FIG. 18 is a third flowchart illustrating the flow of the simulation parameter deriving process. A point different from the flowchart illustrated in FIG. 10 is step S1801.

In step S1801, the parameter deriving device 120 changes the values of the simulation parameter based on the design experiments, and inputs the changed values of the simulation parameter into the shape simulator 130.

### SUMMARY

As is apparent from the above description, the parameter deriving apparatus according to the third embodiment changes the values of the simulation parameter to be input into the shape simulator based on the design of experiments when deriving the optimum values of the simulation parameter.

With this, according to the third embodiment, the number of the operations of the shape simulator can be reduced in deriving the optimum values of the simulation parameter.

### Other Embodiments

In the description of the first and second embodiments, the value changing unit determines the change direction and the change amount of the value of the simulation parameter based on the sum of the respective difference values and the determination result as to whether the sum of the difference values has increased or decreased that are provided by notification by the difference value acquiring unit 805.

However, the method of determining the change direction and the change amount performed by the value changing unit is not limited to this. For example, a relationship between the sum of the respective difference values; and the change direction and the change amount may be obtained in advance by machine learning. This allows the value changing unit to determine the change direction and the change amount of the value of the simulation parameter, using a learning result (a model) obtained by the machine learning.

Additionally, in each of the above-described embodiments, the method of generating the item of the simulation parameter by the aggregating unit has not been described in detail. However, for example, the aggregating unit may obtain a relationship between the item and value of the process data, the item and value of the recipe parameter, and the like included in Proxel and the item of the simulation parameter in advance by machine learning. This allows the aggregating unit to generate the item of the simulation parameter, using a learning result (a model) obtained by the machine learning.

In the description of each of the above-described embodiments, the values of the simulation parameter that minimize the sum of the respective difference values is derived as the optimum values of the simulation parameter. However, the method of deriving the optimum values of the simulation parameter is not limited to this, and for example, the values of the simulation parameter that minimize a value obtained by weighting and adding the respective difference values may be derived as the optimum values of the simulation parameter.

Additionally, in each of the above-described embodiments, the parameter deriving device 120 and the shape simulator 130 are configured as separate components. However, the parameter deriving device 120 and the shape simulator 130 may be configured as one component.

Additionally, in each of the above-described embodiments, the simulation data has been described as including the combinations of the pre-processing cross-sectional images and the post-processing cross-sectional images as an example of a combination of data indicating the shape of the substrate before processing and data indicating the shape of the substrate after processing. However, the combination of the data indicating the shape included in the simulation data is not limited to the cross-sectional image, and may be a two dimensional image or a three dimensional image processed for the shape simulator 130.

Alternatively, it may be a two dimensional image or a three dimensional image or data processed for the shape simulator 130 based on an image or data other than a cross-sectional image. Specifically, it may be:
two dimensional or three dimensional shape simulator data created based on the cross-sectional image;
three dimensional shape simulator data created based on an image when observed from above;
a combination of two dimensional or three dimensional shape simulator data created based on contour data acquired by a measuring device that acquires contour data;
three dimensional shape simulator data created as an ideal shape from dimension data or the like (three dimensional shape simulator data restored based on an image when viewed from directly above and a cross-sectional image); or the like.

Additionally, in the description of each of the above-described embodiments, the parameter deriving program is singly executed by the parameter deriving device 120. However, for example, in a case where the parameter deriving device 120 is configured by multiple computers and the parameter deriving program is installed in the multiple computers, the parameter deriving program may be executed in a form of distributed computing.

Additionally, in each of the above-described embodiments, as an example of a method of installing the parameter deriving program in the auxiliary storage device 203, the method of downloading and installing the parameter deriving program via a network (which is not illustrated) has been described. At this time, although a download source is not particularly described, when the parameter deriving program is installed by such a method, the download source may be, for example, a server device in which the parameter deriving program is accessibly stored. Additionally, the server device may be, for example, a device on a cloud that receives an access from the parameter deriving device 120 via a network (which is not illustrated) and downloads the parameter deriving program on condition of charging. That is, the server device may be a device on a cloud that provides a service for providing the parameter deriving program.

Here, the present invention is not limited to the configurations described herein, such as the configurations described in the above embodiments, combinations with other elements, and the like. These points can be changed within a range not departing from the gist of the present invention, and can be appropriately determined according to the application form.

This application is based upon and claims the priority to Japanese Patent Application No. 2020-218976 filed on Dec. 28, 2020, the entire contents of which are incorporated herein by reference.

### DESCRIPTION OF REFERENCE NUMERALS

100: shape simulation system
110: substrate processing apparatus
111: measuring device
112: measuring device
120: parameter deriving device
121: parameter deriving unit
130: shape simulator
300: collection data
410: simulation data generating unit
420: acquiring unit
430: aggregating unit
440: simulation parameter calculating unit
450: difference calculating unit
460: output unit
510 to 530: simulation data
801: simulation parameter item acquiring unit
802: initial value setting unit
803: simulation parameter input unit
804: value changing unit
805: difference value acquiring unit
1110: constraint condition defining unit
1120: simulation parameter calculating unit
1401: constraint condition setting unit
1611: value changing unit

1. A parameter deriving device comprising:
a processor; and
a memory storing program instructions that cause the processor to:
generate a plurality of combinations of data indicating pre-processing shapes and data indicating post-processing shapes of substrates processed under a same processing condition, data indicating a pre-processing shape or a post-processing shape being different from data indicating a pre-processing shape or a post-processing shape included in another combination in the plurality of combinations; and
derive a value of a simulation parameter of a shape simulator that minimizes a sum of respective differences between data indicating predicted post-processing shapes and data indicating corresponding post-processing shapes, the predicted post-processing shapes being predicted by inputting the data indicating the pre-processing shapes included in the plurality of combinations into the shape simulator.

2. The parameter deriving device as claimed in claim 1, wherein the plurality of combinations includes the data indicating the pre-processing shapes and the data indicating the post-processing shapes that are different from each other in an aspect ratio, in a mask shape, in a film type and a relative position thereof, in a surface state, or in a surrounding aperture ratio.

3. The parameter deriving device as claimed in claim 1, wherein the processor repeatedly performs a process of calculating the sum of the respective differences by inputting the data indicating the pre-processing shapes and the simulation parameter into the shape simulator while changing a value of the simulation parameter, to derive the value of the simulation parameter of the shape simulator that minimizes the sum of the respective differences.

4. The parameter deriving device as claimed in claim 3, wherein the processor changes the value of the simulation parameter that is input into the shape simulator by using a model obtained by machine learning.

5. The parameter deriving device as claimed in claim 1, wherein the substrates processed under the same processing condition include substrates processed under a processing condition that causes a substantially same shape change upon processing.

6. The parameter deriving device as claimed in claim 5, wherein items of the simulation parameter of the shape simulator include respective categories of reaction elements having no overlap as physical phenomenon when the substrates are processed.

7. The parameter deriving device as claimed in claim 1, wherein the differences between the data indicating the predicted post-processing shapes and the data indicating the corresponding post-processing shapes include a difference of an area, a difference of a taper angle, a difference of a depth, a difference of a bowing, or a difference of a critical dimension.

8. The parameter deriving device as claimed in claim 1, wherein the processor changes the value of the simulation parameter under a predetermined constraint condition.

9. The parameter deriving device as claimed in claim 8, wherein the predetermined constraint condition defines a sharing relationship, a hierarchical relationship, or a ratio relationship between the value of the simulation parameter changed when the sum of the respective differences is minimized with respect to the plurality of combinations of the data indicating pre-processing shapes and the data indicating the post-processing shapes of the substrates processed under a first processing condition; and the value of the simulation parameter changed when the sum of the respective differences is minimized with respect to the plurality of combinations of the data indicating pre-processing shapes and the data indicating the post-processing shapes of the substrates processed under a second processing condition.

10. The parameter deriving device as claimed in claim 1, wherein the processor changes the value of the simulation parameter based on a design of experiments.

11. A parameter deriving device method:
generating a plurality of combinations of data indicating pre-processing shapes and data indicating post-processing shapes of substrates processed under a same processing condition, data indicating a pre-processing shape or a post-processing shape being different from data indicating a pre-processing shape or a post-processing shape included in another combination in the plurality of combinations; and
deriving a value of a simulation parameter of a shape simulator that minimizes a sum of respective differences between data indicating predicted post-processing shapes and data indicating corresponding post-processing shapes, the predicted post-processing shapes being predicted by inputting the data indicating the pre-processing shapes included in the plurality of combinations into the shape simulator.

12. A non-transitory computer-readable recording medium having stored therein a parameter deriving device program for causing a computer to perform:
generating a plurality of combinations of data indicating pre-processing shapes and data indicating post-processing shapes of substrates processed under a same processing condition, data indicating a pre-processing shape or a post-processing shape being different from data indicating a pre-processing shape or a post-processing shape included in another combination in the plurality of combinations; and
deriving a value of a simulation parameter of a shape simulator that minimizes a sum of respective differences between data indicating predicted post-processing shapes and data indicating corresponding post-processing shapes, the predicted post-processing shapes being predicted by inputting the data indicating the pre-processing shapes included in the plurality of combinations into the shape simulator.
